(19) United States
(12) Patent Application Publication
(10) Pub. No.: US 2013/0061171 A1
(43) Pub. Date: Mar. 7, 2013

(54) DISPLAY APPARATUS AND UI PROVIDING METHOD THEREOF

(71) Applicants: Nam-wook KANG, Seoul (KR); Jong-hyun RYU, Suwon-si (KR); Seung-eok CHOI, Suwon-si (KR)

(72) Inventors: Nam-wook KANG, Seoul (KR); Jong-hyun RYU, Suwon-si (KR); Seung-eok CHOI, Suwon-si (KR)

(73) Assignee: Samsung Electronics Co., Ltd., Gyeonggi-do (KR)

(21) Appl. No.: 13/599,357

(22) Filed: Aug. 30, 2012

(30) Foreign Application Priority Data
Sep. 1, 2011 (KR) 10-2011-0088744

(51) Int. Cl. G06F 3/048

(52) U.S. Cl. 715/800

(57) ABSTRACT

A display apparatus is provided. The display apparatus includes a display unit for displaying a User Interface (UI) having a size that varies in response to a user's manipulation of the display unit; and a control unit for changing a type of information displayed in the UI in at least one stage in accordance with a state of the manipulated size of the UI.

### PRIORITY

This application claims priority under 35 U.S.C. §119(a) from Korean Patent Application No. 10-2011-0088744, filed on Sep. 1, 2011, in the Korean Intellectual Property Office, the entire content of which is incorporated herein by reference.

### BACKGROUND OF THE INVENTION

1. Field of the Invention

The present invention relates generally to a display apparatus and a User Interface (UI) providing method thereof, and more particularly, to a display apparatus capable of receiving a touch input and a UI providing method thereof.

2. Description of the Related Art

Electronic devices equipped with touch screens can generally provide easy access to data because the touch screens allow users to directly enter desired menus or data simply by touching the touch screens.

Multi-touch technology has been widely employed in various User Interfaces (UIs) equipped with touch screens. Multi-touch technology involves recognizing the presence of two or more points of contact with the surface of, for example, a touch screen. The multi-touch technology has enabled a variety of touch inputs such as scrolling, zooming in or out, panning, etc., in contrast to existing single-touch technology, which may be merely used for detecting the presence and location of a single touch.

In order to improve the readability of information displayed by a mobile device equipped with a touch screen regardless of the limited display size of the touch screen, various manipulations for enlarging or reducing a display screen may be needed.

However, due to their limited display size, mobile devices may often not be able to properly display certain types of information, such as calendar data, regardless of whether the information can be enlarged to its maximum.

In addition, mobile devices may not be able to properly present certain types of information, such as a schedule table, in such a manner that the information can be easily identified.

### SUMMARY OF THE INVENTION

Embodiments of the present invention are provided to address above-described problems and/or disadvantages, as well as other disadvantages not described above, but embodiments of the present invention are not all required to overcome the above-described disadvantages.

The present invention provides a display apparatus capable of changing the state of the display of information in one or more stages in response to the manipulation of the size of a user interface (UI) and a UI providing method of the display apparatus.

According to an aspect of the present invention, a display apparatus is provided. The apparatus includes a display unit for displaying a User Interface (UI) having a size that varies in response to a user's manipulation of the display unit; and a control unit for changing a type of information displayed in the UI in at least one stage in accordance with a state of the manipulated size of the UI.

According to another aspect of the present invention, a method of providing a UI is provided. The method includes displaying a UI having a size that varies in response to a user's manipulation thereof; and changing a type of information displayed in the UI in at one stage in accordance with a state of the manipulated size of the UI.

### BRIEF DESCRIPTION OF THE DRAWINGS

The above and/or other aspects of the present invention will be more apparent by describing certain embodiments of the present invention with reference to the accompanying drawings, in which:

FIG. 1 is a block diagram illustrating a display apparatus according to an embodiment of the present invention;

FIGS. 2A to 2C are diagrams illustrating an example of changing the type of information displayed in a UI in response to the manipulation of the size of the UI according to an embodiment of the present invention;

FIGS. 3A to 3C are diagrams illustrating another example of changing the type of information displayed in a UI in response to the manipulation of the size of the UI according to an embodiment of the present invention;

FIG. 4 is a block diagram illustrating a display apparatus according to another embodiment of the present invention;

FIGS. 5A and 5B are diagrams illustrating an example of storing a scheduled event in connection with an icon according to an embodiment of the present invention;

FIGS. 6A to 6C are diagrams illustrating an example of matching a scheduled event with a cell according to an embodiment of the present invention;

FIGS. 7A to 7C are diagrams illustrating another example of matching a scheduled event with a cell of a schedule table according to an embodiment of the present invention;

FIGS. 8A to 8D are diagrams illustrating an example of searching for a predetermined scheduled event from a cell to which more than one scheduled event is matched according to an embodiment of the present invention;

FIGS. 9A to 9D are diagrams illustrating another example of searching for a predetermined scheduled event from a cell to which more than one scheduled event is matched according to an embodiment of the present invention;

FIGS. 10A and 10B are diagrams illustrating an example of searching for an icon from a schedule table according to an embodiment of the present invention; and

FIG. 11 is a flowchart illustrating a UI providing method of a display apparatus according to an embodiment of the present invention.

### DETAILED DESCRIPTION OF EMBODIMENTS OF THE PRESENT INVENTION

Hereinafter, certain embodiments of the present invention are described in greater detail with reference to the accompanying drawings. Similar components may be designated by similar reference numerals although they are illustrated in different drawings. In the following description, a detailed explanation of known related functions and constitutions may be omitted to avoid unnecessarily obscuring the subject matter of the present invention.

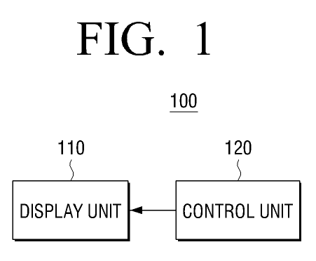

FIG. 1 is a block diagram illustrating a display apparatus according to an embodiment of the present invention.

Referring to FIG. 1, a display apparatus 100 includes a display unit 110 and a control unit 120. The display unit 110 displays a User Interface (UI) having a size that varies in response to a user's manipulation thereof. The size of the UI may be adjusted by a pinch-in operation or a pinch-out operation. More specifically, the display unit 110 may display a UI whose size increases in response to a pinch-in operation performed by a user and decreases in response to a pinch-out operation performed by the user.

For example, the UI may be a table UI that is divided into a plurality of cells. The display unit 110 may be implemented as a touch pad that performs both data input and output functions.

The control unit 120 may control each element of the display apparatus 100, and may thus control a general operation of the display apparatus 100. The control unit 120 may change the type of information displayed in the UI in one or more stages in response to the manipulation of the size of the UI.

For example, when the UI is displayed at a minimum size, the control unit 120 may display information in the UI as an icon. Then, in response to an increase in the size of the UI, the control unit 120 may additionally display, in the UI, text data corresponding to the icon, which has gradual depth according to a predetermined hierarchical structure.

The text data with gradual depth may have a hierarchical structure including an upper level and one or more lower levels, and text data corresponding to each level of the hierarchical structure may include detailed information associated with the icon.

Text data corresponding to each level of the hierarchical structure may have a title. For example, upper-level text data may have a title, which may be referred to as a main title, and lower-level text data may have a title, which may be referred to as a sub-title. For example, the term ‘text data corresponding to an icon’ may include detailed information associated with or represented by the icon.

When the icon represents a hospital, the text data corresponding to the icon may include detailed information on a scheduled event associated with a hospital, and may have a hierarchical structure. For example, the text data corresponding to the icon may include “Title: hospital appointment” as upper-level text data and “Appointment Time: 3 P.M.,” and “Location: Seoul National University Hospital” as lower-level text data. In this example, “Title” “Appointment Time,” and “Location” may be classified as titles, and “hospital appointment,” “3 P.M.,” and “Seoul National University Hospital” may be classified as content.

The text data corresponding to the icon may be configured to only include content such as, for example, “hospital appointment,” “3 P.M.,” and “Seoul National University Hospital.”

The control unit 120 may classify the size of the UI into a plurality of stages. Then, the control unit 120 may display only the icon in the UI at a minimum size stage of the UI, and may gradually display text in the UI in response to the size of the UI gradually increasing from one stage to another stage. More specifically, the control unit 120 may display text together with the icon in response to the manipulation of the size of the UI while increasing the amount of information displayed in the UI in connection with the icon in one or more stages in accordance with the increase of the size of the UI.

For example, when the UI is displayed at a minimum size, the control unit 120 may only display the icon in the UI. In response to the UI being enlarged to a first reference level by a pinch-in operation performed by the user, the control unit 120 may display the title and content of upper-level text data corresponding to the icon in the UI together with the icon. In response to the size of the UI reaching a second reference level by being further increased by another pinch-in operation performed by the user, the control unit 120 may display the title and content of lower-level text data corresponding to the icon in the UI together with the icon. In this example, the control unit 120 may display only one of the title and content of the upper- or lower-level text data.

According to another example, the control unit 120 may display the content of the upper-level text data in the UI in response to the size of the UI reaching the first reference level, and may display the title of the upper-level text data and the title and the content of the lower-level text data in the UI in response to the size of the UI reaching the second reference level.

More specifically, the control unit 120 may display various combinations of the title and the content of each level of the text data corresponding to the icon.

The control unit 120 may display a table UI, which is divided into a plurality of cells, on the display unit 110. In response to selection of a cell into which data is written from among the plurality of cells, the control unit 120 may control the display unit 110 to display a UI while changing the type of information displayed in the UI in one or more stages, in response to the manipulation of the size of the UI.

The display unit 110 may display a table UI, which is divided into a plurality of cells. In this case, in response to the change of the size of a data-written cell, among other cells, the control unit 120 may change the type of information displayed in the data-written cell in one or more stages in accordance with a change in the size of the data-written cell.

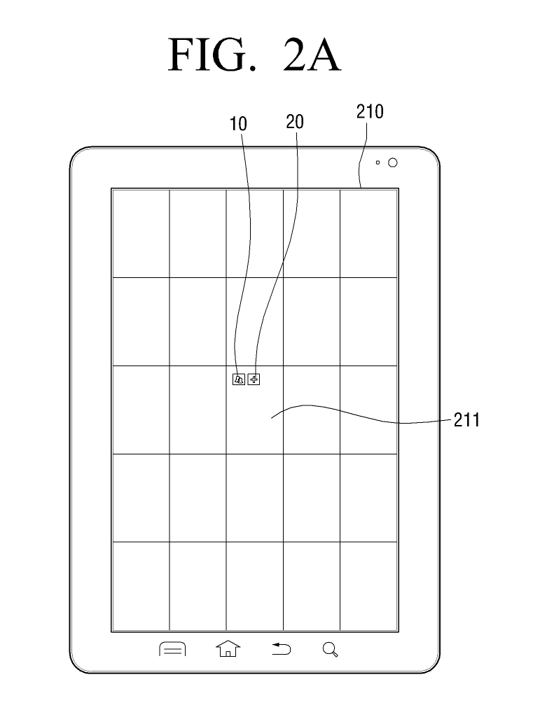

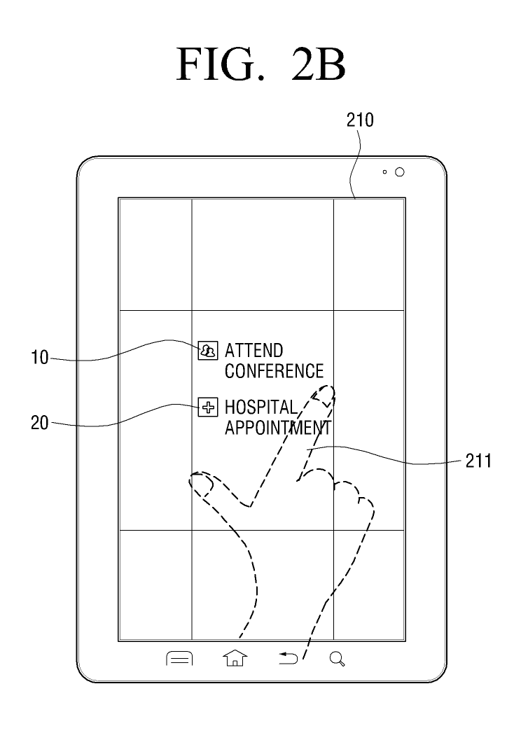

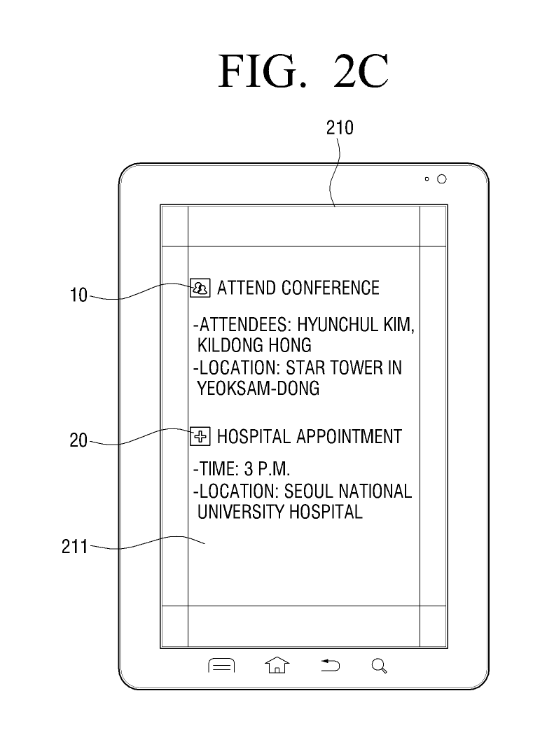

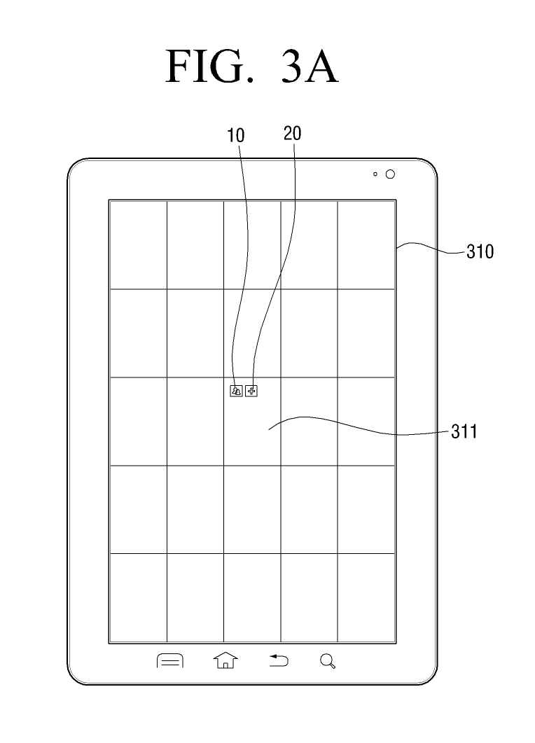

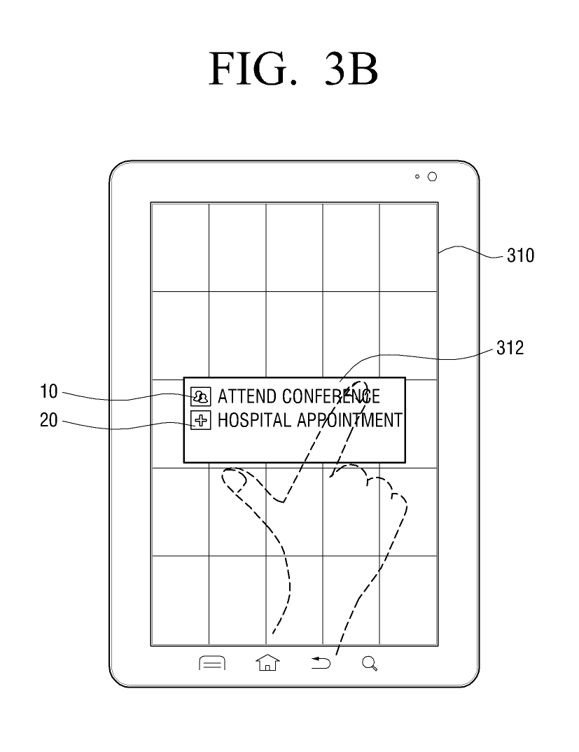

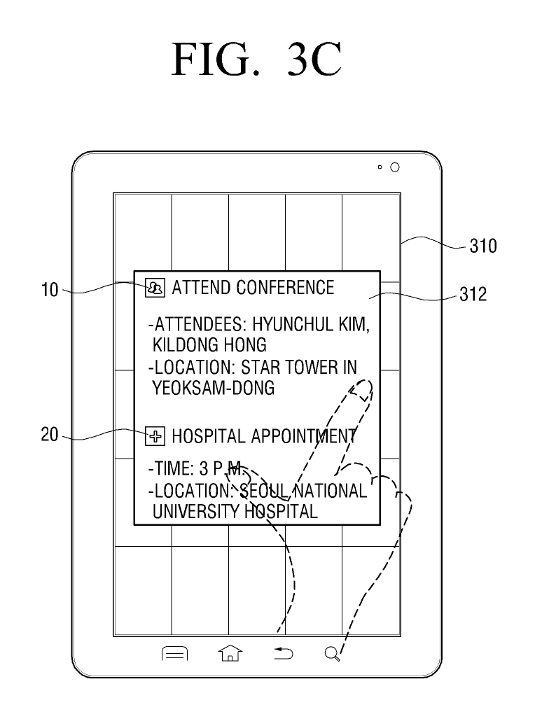

Operations of the control unit 120 are further described as follows with reference to FIGS. 2A to 3C.

FIGS. 2A to 2C are diagrams illustrating an example of changing the type of information displayed in a UI in response to manipulation of the size of the UI according to an embodiment of the present invention.

Referring to FIGS. 2A to 2C, when a table UI including a plurality of cells is displayed and the size of a cell in which data is written changes, the type of information displayed in the data-written cell may change in one or more stages in accordance with a change in the size of the data-written cell. In the present example, the term ‘information’ may include an icon and text data corresponding to an icon.

More specifically, referring to FIG. 2A, a UI that is divided into a plurality of cells including a cell 211 are displayed on a display unit 210, and the cell 211 is a data-written cell. Since the data-written cell 211 is displayed in its minimum size, only a ‘conference’ icon 10 and a ‘hospital’ icon 20 may be displayed in the data-written cell 211.

In response to the size of the data-written cell 211 being changed by a pinch-in operation performed by a user, the type of information displayed in the data-written cell 211 may change in one or more stages in accordance with the size change. In response to the size of the data-written cell 211 increasing, text data may be displayed in the data-written cell 211 along with each of the ‘conference’ icon 10 and the ‘hospital’ icon 20, such as illustrated in FIG. 2B, for example.

Referring to FIG. 2B, in response to the data-written cell 211 being enlarged to a first reference level, upper-level text data corresponding to the ‘conference’ icon 10 (i.e., ‘Attend Conference’) and upper-level text data corresponding to the ‘hospital’ icon 20 (i.e., ‘Hospital Appointment’) are displayed in the data-written cell 211.

In the example illustrated in FIG. 2B, only the content of upper-level text data are displayed along with an icon. According to another example, “Title: Attend Conference” may be displayed as the upper-level text data corresponding to the ‘conference’ icon 10, and “Title: Hospital Appointment” may be displayed as the upper-level text data corresponding to the ‘hospital’ icon 20.

Referring to FIG. 2C, in response to the data-written cell 211 being further enlarged to a second reference level, the upper-level text data corresponding to the ‘conference’ icon 10 and the ‘hospital’ icon 20 are displayed along with lower-level text data corresponding to the ‘conference’ icon 10 (i.e., “Attendees: Hyunchul Kim, Kildong Hong” and “Location: Star Tower in Yeoksam-dong”) and lower-level text data corresponding to the ‘hospital’ icon 20 (i.e., “Time: 3 P.M.,” and “Location: Seoul National University Hospital,”) in the data-written cell 211.

In the example illustrated in FIG. 2C, the title and content of lower-level text data corresponding to an icon are displayed along with the icon. According to another example, only the content of the lower-level text data may be displayed along with the icon.

Referring to FIGS. 2B and 2C, in response to the size of the data-written cell 211 increasing, text data may be displayed along with each of the ‘conference’ and ‘hospital’ icons 10 and 20. The amount of text data displayed in the data-written cell 211 may increase in accordance with an increase in the size of the data-written cell 211.

FIGS. 3A to 3C are diagrams illustrating an example of changing the type of information displayed in a UI in response to the manipulation of the size of the UI according to an embodiment of the present invention.

Referring to FIGS. 3A to 3C, a table UI including a plurality of cells are displayed on a display unit 310. In response to a data-written cell being selected from the plurality of cells, the type of information displayed in the data-written cell change in accordance with the manipulation of the size of the data-written cell. In the present example, the term ‘information’ may include an icon and text data corresponding to an icon.

More specifically, referring to FIG. 3A, a first UI that is divided into a plurality of cells including a cell 311 may be displayed on the display unit 310, and the cell 311 may be a data-written cell. Since the data-written cell 311 is displayed at a minimum size, only a ‘conference’ icon 10 and a ‘hospital’ icon 20 are displayed in the data-written cell 311.

In response to the data-written cell 311 being selected by a touch operation performed by a user, the display unit 310 may display a second UI that changes the type of information displayed therein, in one or more stages, in accordance with the manipulation of the size thereof. The type of information that may be displayed in the second UI may change, in one or more stages, in response to the manipulation of the size of the second UI by the user. More specifically, in response to the size of the second UI increasing, text data may be displayed along with each of the ‘conference’ and ‘hospital’ icons 10 and 20, such as in FIG. 3B, for example.

Referring to FIG. 3B, in response to the data-written cell 311 being selected from the display unit 310, a second UI 312 that changes the type of information displayed therein in response to the manipulation of the size thereof is displayed. In response to the increase of the size of the second UI 312 to a first reference level by a pinch-in operation performed by a user, “Attend Conference” and “Hospital Appointment” are displayed as upper-level text data corresponding to the ‘conference’ icon 10 and the ‘hospital’ icon 20 together with the ‘conference’ icon 10 and the ‘hospital’ icon 20, respectively.

In the example illustrated in FIG. 3B, only the content of upper-level text data is displayed along with each respective icon. According to another example, “Title: Attend Conference” may be displayed as the upper-level text data corresponding to the ‘conference’ icon 10, and “Title: Hospital Appointment” may be displayed as the upper-level text data corresponding to the ‘hospital’ icon 20.

Referring to FIG. 3C, in response to the data-written cell 311 being further enlarged to a second reference level, the second UI 312 displays the upper-level text data corresponding to the ‘conference’ icon 10 and the ‘hospital’ icon 20, as well as lower-level text data corresponding to the ‘conference’ icon 10 (i.e., “Attendees: Hyunchul Kim, Kildong Hong” and “Location: Star Tower in Yeoksam-dong”) and lower-level text data corresponding to the ‘hospital’ icon 20 (i.e., “Time: 3 P.M.,” and “Location: Seoul National University Hospital,”).

In the example illustrated in FIG. 3C, the title and the content of lower-level text data corresponding to an icon may both be displayed along with each respective icon. According to another example, only the content of the lower-level text data may be displayed along with the icon.

In the examples illustrated in FIGS. 2A to 3C, text data may be displayed together with an icon in response to a pinch-in operation being performed by a user. According to another example, in response to a pinch-out operation being performed by the user, the size of a cell or a UI may gradually decrease, and the amount of text data displayed in the cell or the UI together with an icon may also gradually decrease until the size of the cell or the UI reaches its minimum. In response to the size of the cell or the UI reaching its minimum, only the icon (i.e., the icon without the additional text data) is displayed in the cell or the UI.

In the examples illustrated in FIGS. 2A to 3C, text data including upper-level text data and lower-level text data may be displayed in one or more stages according to a hierarchy therein in accordance with a variation in the size of a UI. However, embodiments of the present invention are not limited to the examples illustrated in FIGS. 2A to 3C.

Embodiments of the present invention can be applied to text data not specifically having a hierarchical structure therein, for example, text data including information with different priority levels. For example, when text data includes important information with a high priority level and regular information with a low priority level, an icon may be displayed in a UI or a cell in response to the UI or the cell being displayed in its minimum size. In this case, in response to the size of the UI or the cell increasing, the important information may be displayed along with the icon. Then, in response to the size of the UI or the cell further increasing, the regular information may also be displayed along with the icon.

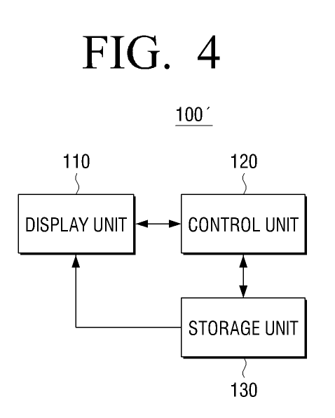

FIG. 4 is a block diagram illustrating a display apparatus according to another embodiment of the present invention.

Referring to FIG. 4, a display apparatus 100′ includes a display unit 110, a control unit 120, and a storage unit 130. The display apparatus 100′ is the same as the display apparatus 100 illustrated in FIG. 1 except that the display apparatus 100′ further includes the storage unit 130. The following description of the operation of the display apparatus 100′ mainly focuses on the differences from the operations of the display apparatus 100. For a better understanding of the operation of the display apparatus 100′, two examples are given as follows with reference to FIG. 4:

### Example 1

The display unit 110 displays a schedule table including a plurality of cells. The schedule table may be a calendar for schedule management for a user.

The control unit 120 matches schedule information including an icon and a scheduled event set by the user to a cell selected from the schedule table by the user, and stores the results of the matching in the storage unit 130. In response to one of the cells being selected, the control unit 120 controls the display unit 110 to generate a UI whose size can vary in response to the user's manipulation thereof and to display schedule information in the selected cell.

When a plurality of pieces of schedule information is matched to a cell, the control unit 120 controls the display unit 110 to display the plurality of pieces of schedule information in their chronological order.

The display unit 110 displays an icon selection UI (i.e., a UI for selecting an icon). In response to an icon being selected from the icon selection UI, the display unit 110 may display a scheduled event UI for entering a scheduled event into the selected icon.

According to Example 1, the control unit 120 controls a scheduled event entered via the scheduled event UI to be stored in connection with the selected icon. In response to the occurrence of a predefined event, the control unit 120 displays an icon list including one or more scheduled event-matched icons, which are icons each having a scheduled event matched therewith, on one side of the schedule table, and controls one of the scheduled event-matched icons to be stored in connection with at least one of the cells of the schedule table in accordance with a user command.

In response to selection of one of the cells of the schedule table, the display unit 110 displays at least one icon matched to the selected cell on one side of the schedule table. In response to selection of one of the scheduled event-matched icons, the control unit 120 may control the selected scheduled event-matched icon to be displayed in one or more cells to which the selected scheduled event-matched icon is matched.

### Example 2

The display unit 110 displays a schedule table including a plurality of cells whose size varies in response to a user's manipulation thereof. The schedule table is a calendar for schedule management for the user.

The control unit 120 controls schedule information including an icon and a scheduled event set by the user to be stored in the storage unit 130 in connection with a cell selected from the schedule table by the user.

When a plurality of pieces of schedule information is matched to a cell, the control unit 120 controls the display unit 110 to display the plurality of pieces of schedule information in chronological order. The display unit 110 displays an icon selection UI. In response to an icon being selected from the icon selection UI, the display unit 110 displays a scheduled event UI for entering a scheduled event into the selected icon.

According to Example 2, the control unit 120 may control a scheduled event entered via the scheduled event UI to be stored in connection with the selected icon.

In response to the occurrence of a predefined event, the control unit 120 may display an icon list including one or more scheduled event-matched icons on one side of the schedule table, and may control one of the scheduled event-matched icons to be stored in connection with at least one of the cells of the schedule table in accordance with a user command.

In response to selection of one of the cells of the schedule table, the display unit 110 displays at least one icon matched to the selected cell on one side of the schedule table.

In response to selection of one of the scheduled event-matched icons, the control unit 120 controls the selected scheduled event-matched icon to be displayed in one or more cells to which the selected scheduled event-matched icon is matched.

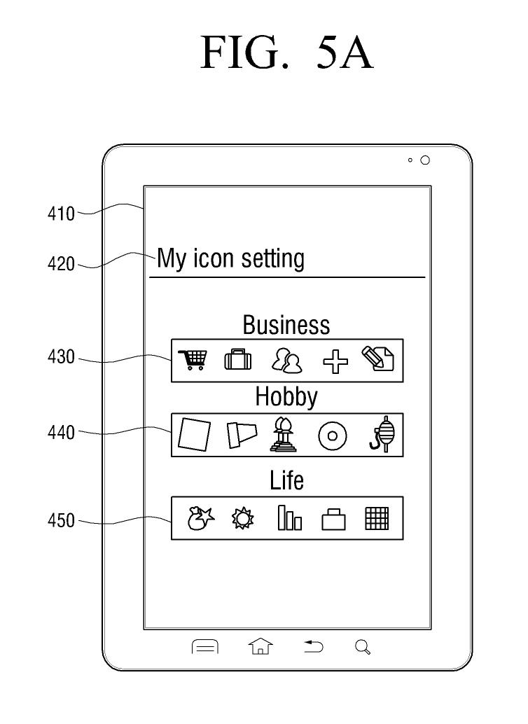

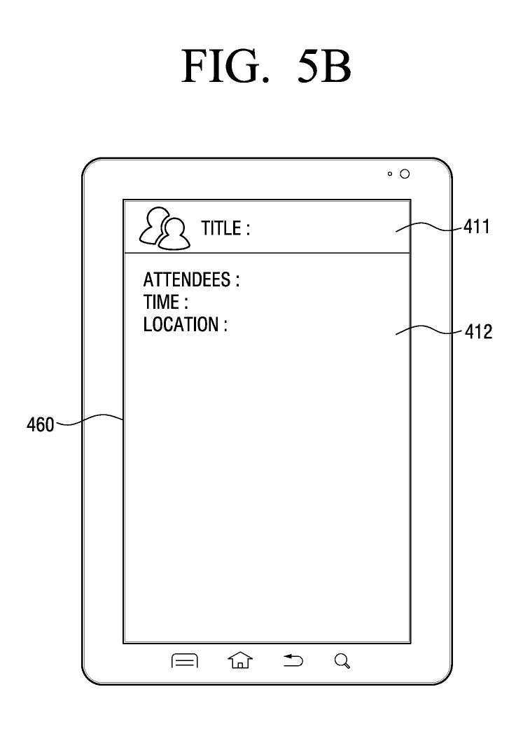

FIGS. 5A and 5B are diagrams illustrating an example of storing a scheduled event in connection with an icon according to an embodiment of the present invention.

Referring to FIG. 5A, a user may store a scheduled event in connection with an icon by using a “My icon setting” menu screen 410. One or more icons may be displayed on the “My icon setting” menu screen 410. The displayed icons may be classified into one or more categories according to their properties. The displayed icons may be determined by default setting at the time of the manufacture of a display apparatus, and/or new icons may be added thereto or some of the displayed icons may be deleted by the user. For example, in FIG. 5A, the displayed categories include, but are not limited to, a ‘Business’ category 430, a ‘Hobby’ category 440, and a ‘Life’ category 450.

Referring to FIG. 5B, in response to selection of one of the displayed icons of FIG. 5A, a scheduled event UI 460 for entering a scheduled event in connection with the selected icon is displayed. The scheduled event UI 460 includes a main entry 411 for entering the title of text data corresponding to the selected icon and a main entry 412 for entering the content of the text data.

The title that may be entered into the main entry 411 is a title for upper-level text data corresponding to the selected icon, i.e., the user may enter detailed information for the main title into the main entry 412.

The main entry 412 may include one or more sub-entries, and each of the sub-entries may have a respective title (i.e., a sub-title). The user may enter detailed information for each of the sub-titles into a corresponding sub-entry of the main entry 412.

The user may enter into the main entry 412 information that is compatible with the properties of the selected icon, and may add any desired sub-entry to the main entry 412, if necessary. For example, when the selected icon belongs to the ‘Business category 430, the main entry 412 may include a ‘title’ entry, an ‘attendees’ entry, a ‘time’ entry, and a ‘location’ entry as its defaults sub-entries, and the user may appropriately enter information of a desired scheduled event into the default sub-entries of the entry 412. In this manner, a scheduled event stored in connection with an icon may include text data with gradual depth according to a predetermined hierarchical structure. More specifically, scheduled event information including upper-level text data and lower-level text data may be stored in connection with each icon.

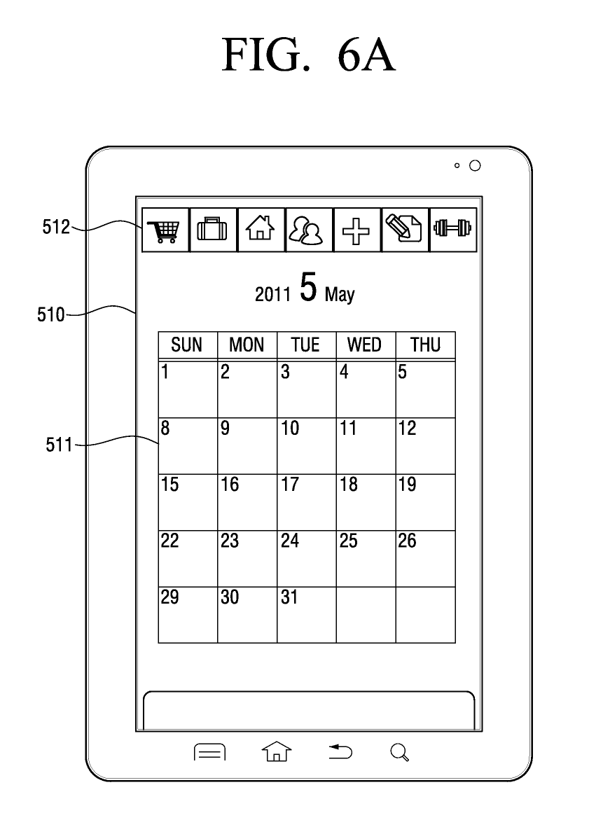

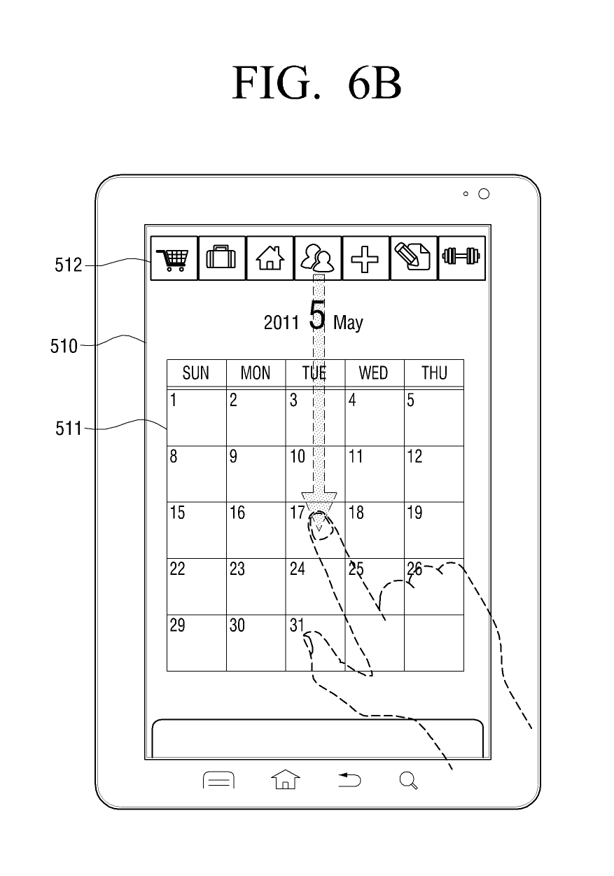

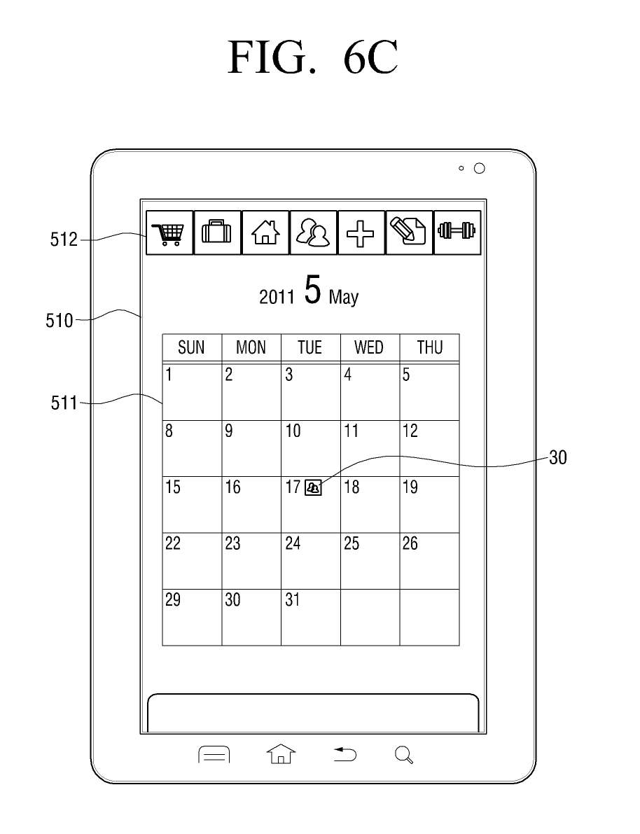

FIGS. 6A to 6C are diagrams illustrating an example of matching a scheduled event to a cell according to an embodiment of the present invention.

Referring to FIG. 6A, a display screen 510 includes a schedule table 511 and an icon list 512 that is displayed on one side of the schedule table 511 and includes one or more scheduled event-matched icons. The icon list 512 may include not only the scheduled event-matched icons but also one or more other icons that are yet to be matched to a scheduled event.

Referring to FIGS. 6B and 6C, in response to one of the scheduled event-matched icons being selected from the icon list 512 by a drag-and-drop operation performed by a user and being placed in a cell of the schedule table 511 corresponding to the date of May 17, 2011, the selected icon may be displayed in the cell, as indicated by reference numeral 30. In this example, a scheduled event entered in connection with to the icon 30, as described above with reference FIG. 5B, may be stored in connection with the cell.

When more than one icon in the icon list 512 is matched to a particular cell of the schedule table 511, the icons may be displayed in chronological order between their respective scheduled events. For example, the icons matched to the particular cell may be displayed one after another in chronological order between their respective scheduled events.

If a particular cell includes an icon for which no time information is yet to be entered, among the icons matched to the particular cell, the icon may be displayed at the front or the rear of the other icons.

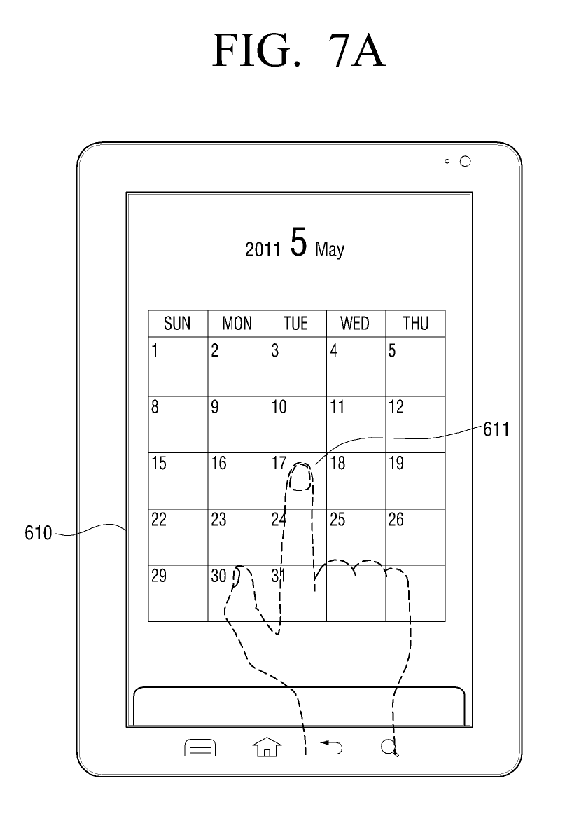

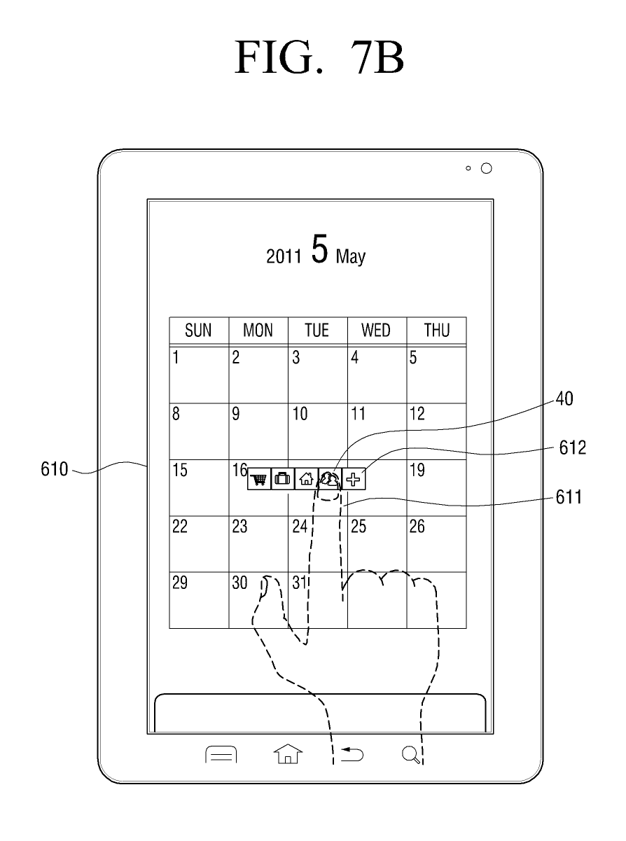

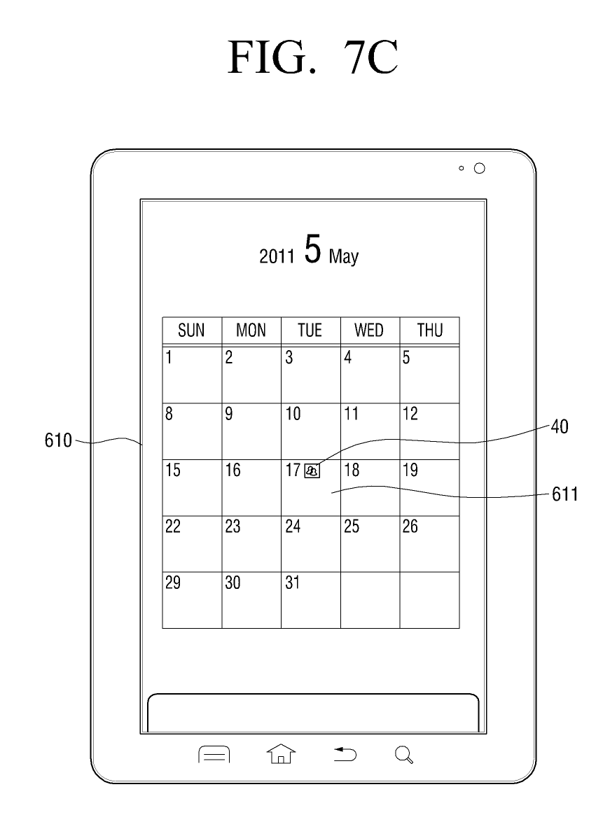

FIGS. 7A to 7C are diagrams illustrating another example of matching a scheduled event to a cell according to an embodiment of the present invention.

Referring to FIGS. 7A and 7B, in response to selection of a cell 611 from a schedule table 610 by a user as shown in FIG. 7A, an icon list 612 including one or more scheduled event-matched icons may be displayed over the cell 611 as shown in FIG. 7B.

Referring to FIGS. 7B and 7C, in response to selection of at least one icon, i.e., an icon 40 as shown in FIG. 7B, from the icon list 612 by a touch-and-drop operation performed by the user, the icon 40 may be displayed in the cell 611 as shown in FIG. 7C. According to the example of FIGS. 7B and 7C, a scheduled event entered in connection with to the icon 40, as described above with reference FIG. 5B may be stored in connection with the cell 611.

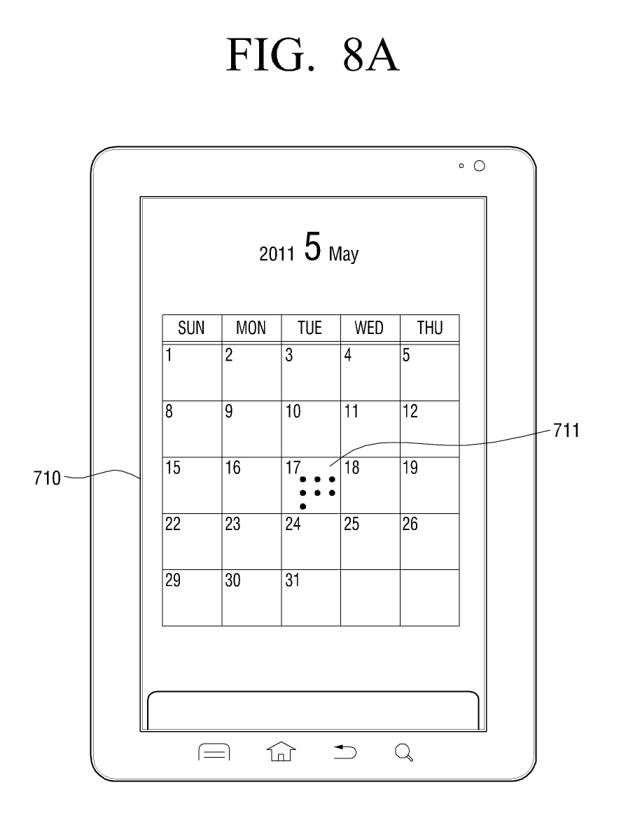

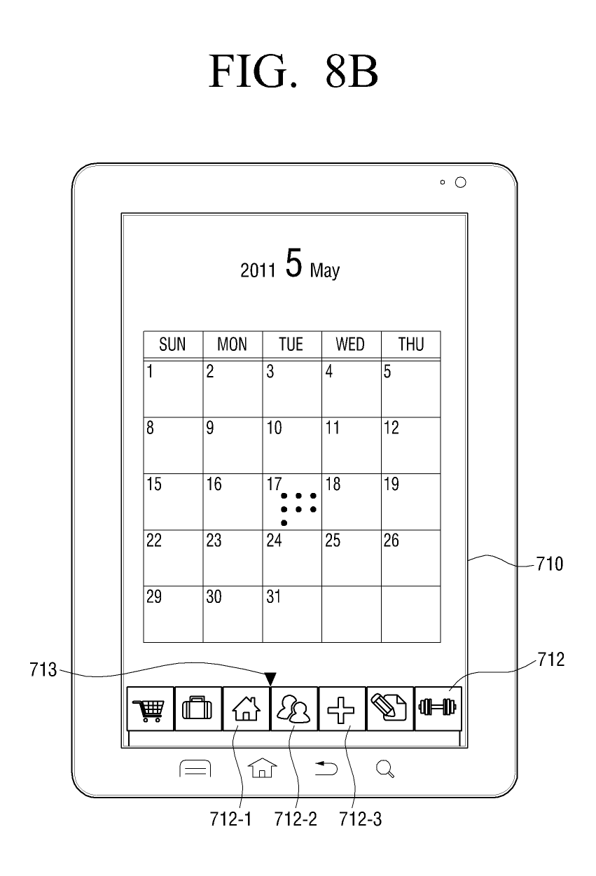

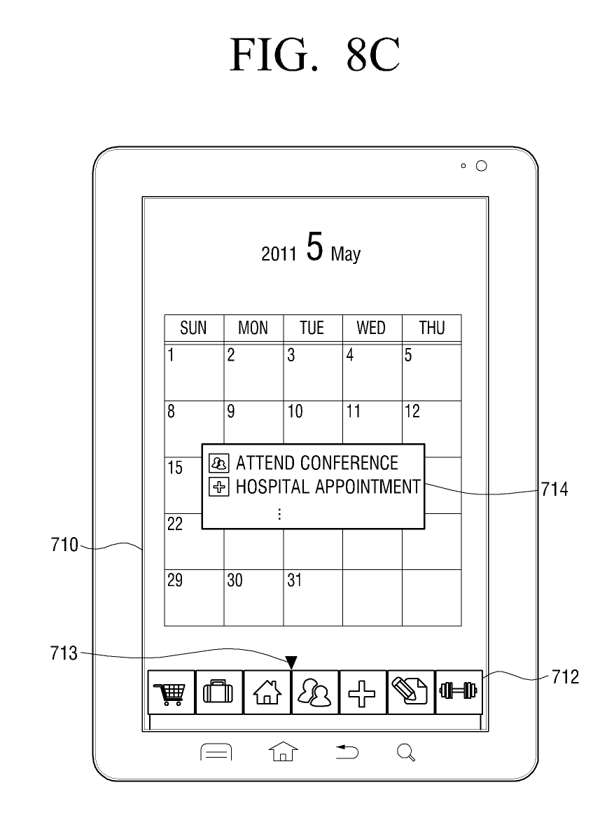

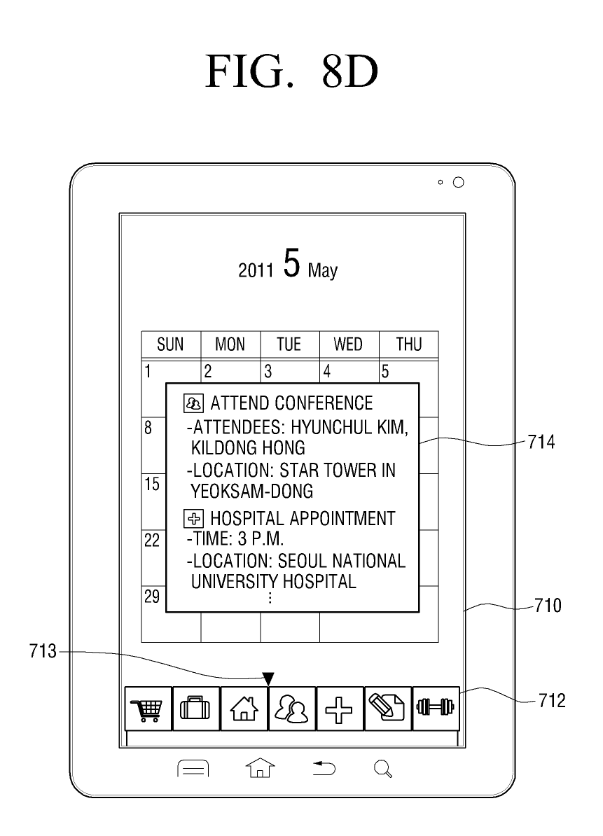

FIGS. 8A to 8D are diagrams illustrating an example of searching for a predetermined scheduled event from a cell to which one or more scheduled events are matched according to an embodiment of the present invention.

Referring to FIG. 8A, a plurality of dots corresponding to a plurality of respective scheduled event-matched icons are displayed in a cell of a schedule table 710 corresponding to the date of May 17, 2011.

Referring to FIGS. 8A and 8B, in response to the cell 711 being touched by a user, an icon list 712 including a plurality of scheduled event-matched icons that are matched to the cell 711 may be displayed on one side of the schedule table 710 as shown in FIG. 8B. The scheduled event-matched icons in the icon list 712 may be arranged according to a predetermined rule.

For example, the scheduled event-matched icons in the icon list 712 may be arranged in chronological order according to their respective scheduled events. More specifically, since a ‘home’ icon 712-1 has time information that indicates a time period of 12:00-13:00, a ‘conference’ icon 712-2 has time information that indicates a time period of 14:00-14:50, and a ‘hospital’ icon 712-3 has time information that indicates a time period of 15:30-16:00, the ‘home’ icon 712-1 is displayed ahead of the ‘conference’ icon 712-2, and the ‘conference’ icon 712-2 is displayed ahead of the ‘hospital’ icon 712-3, as shown in FIG. 8B.

If there is an icon among the scheduled event-matched icons in the icon list 712 that does not have any time information, the icon may be displayed at the front or the rear of the icon list 712.

When displaying the icon list 712, an indicator 713 may also be displayed to indicate the relationship between the current time and the time information of each of the scheduled event-matched icons in the icon list 712. Therefore, the user may readily recognize one or more scheduled events to be carried out.

For example, referring to FIG. 8B, when the current time is 13:30, the indicator 713 may be displayed between the ‘home’ icon 712-1 corresponding to the time period of 12:00-12:30 and the ‘conference’ icon 712-2 corresponding to the time period of 14:00-14:50.

If there is an icon corresponding to a time period including the current time in the icon list 712, the indicator 713 may be displayed at the top of the icon.

Referring to FIG. 8C, in response to the cell 711 being touched for more than a predefined amount of time by the user, a UI 714 that changes the type of schedule information displayed therein in response to the manipulation of the size thereof may be displayed. For example, the term ‘schedule information’ includes an icon matched to a particular cell and a scheduled event entered in connection with an icon. More specifically, in response to the UI 714 being increased by a touch operation performed by the user, the icons matched to the cell 711 and their respective scheduled events are displayed. The amount of schedule information displayed in the UI 714 may increase according to the size of the UI 714.

For example, referring to FIG. 8C, the UI 714 displays a ‘conference’ icon 10 and the main title of text data corresponding to the ‘conference’ icon 10 (i.e., ‘Attend Conference’) and displays a ‘hospital’ icon 20 and the main title of text data corresponding to the ‘hospital’ icon 20 (i.e., ‘Hospital Appointment’).

The schedule information displayed in the UI 714 includes one or more icons that are arranged in the icon list 712 next to the indicator 713. In the present example according to FIG. 8C, in response to the indicator 713 being displayed between the ‘home’ icon and the ‘conference’ icon, the ‘conference’ icon, the ‘hospital’ icon, and other icons that follow the ‘hospital’ icon are displayed in the UI 714, thereby notifying the user of the scheduled events to be carried out according to the current time.

According to another example, the schedule information displayed in the UI 714 may include all the icons matched to the cell 711 and their respective scheduled events.

Referring to FIG. 8D, in response to the UI 714 of FIG. 8A being further enlarged to a predefined reference level, the name of a scheduled event stored in connection with the ‘conference’ icon (i.e., “Attend Conference”) and detailed information of the scheduled event stored in connection with the ‘conference’ icon (i.e., “Hyunchul Kim, Kildong Hong,” and “Star Tower in Yeoksam-dong”) are displayed, and the name of a scheduled event stored in connection with the ‘hospital’ icon (i.e., “Hospital Appointment”) and detailed information of the scheduled event stored in connection with the ‘hospital’ icon (i.e., “3 P.M.” and “Seoul National University Hospital”) are also displayed.

In the examples illustrated in FIGS. 8C and 8D, the content of upper-level text data corresponding to a scheduled event and the title and the content of lower-level text data corresponding to the scheduled event may be displayed. According to another example, the title and the content of the upper-level text data and the title and the content of the lower-level text data may be displayed. According to still another example, only the content of the upper-level text data and the content of the lower-level text data may be displayed.

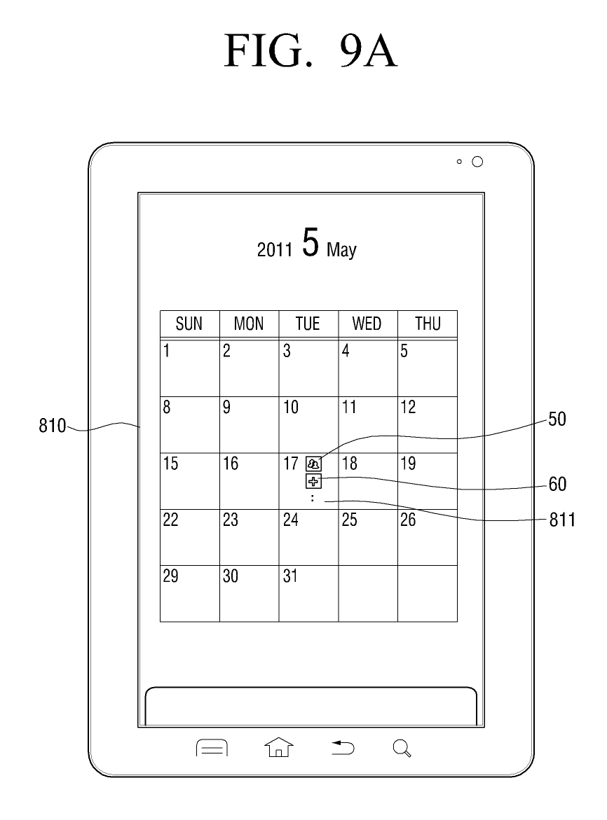

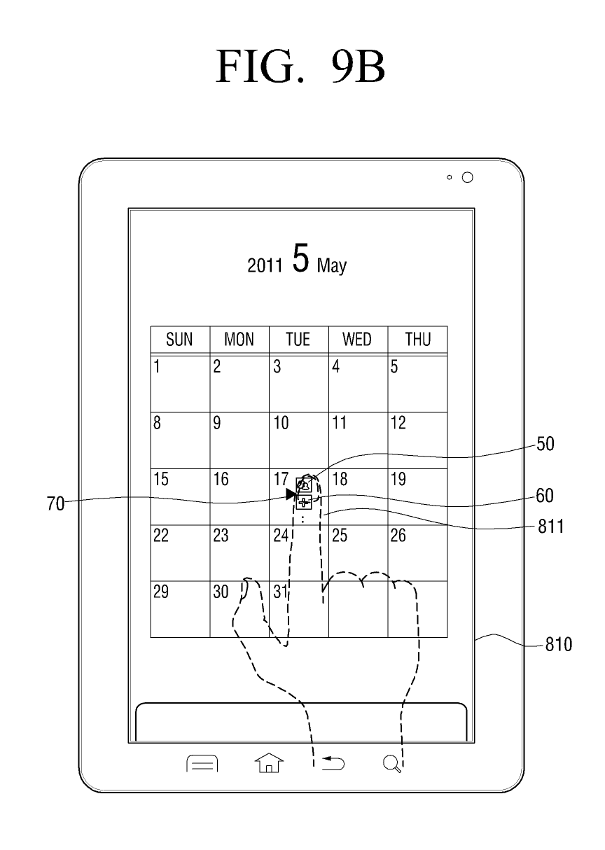

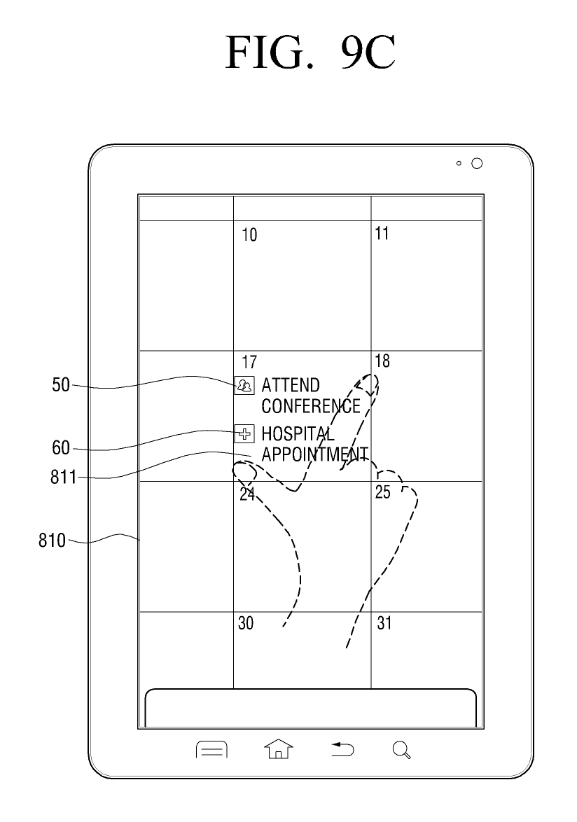

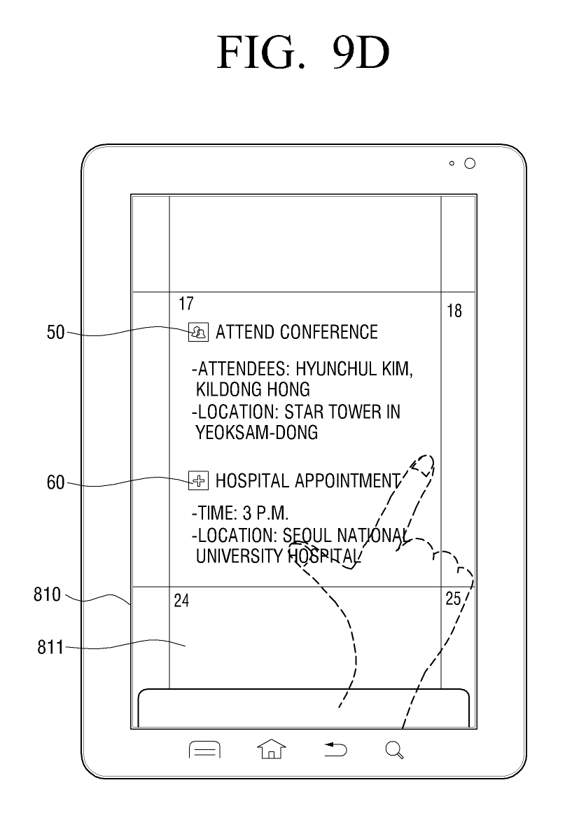

FIGS. 9A to 9D are diagrams illustrating another example of searching a predetermined scheduled event from a cell to which one or more scheduled events are matched according to an embodiment of the present invention.

Referring to FIG. 9A, a cell 811 of a schedule table 810 corresponding to the date of May 17, 2011 displays a plurality of icons, including a ‘conference’ icon 50 and a ‘hospital’ icon 60, and each of the plurality of icons may have a scheduled event matched therewith.

Referring to FIG. 9B, in response to the cell 811 being touched by a user, an indicator 70 indicating the relationship between the current time and time information of each of the ‘conference’ icon 50 and the ‘hospital’ icon 60 is displayed in the cell 811. According to the present example, the location of the indicator 70 is determined based on the time information of each of the ‘conference’ icon 50 and the ‘hospital’ icon 60. The determination of the location of the indicator 70 is been described hereinabove with reference to FIG. 8B, and thus, a further detailed description thereof is omitted.

In response to the size of the cell 811 being changed by a touch operation performed by the user, schedule information that is matched to the cell 811 may be displayed in the cell 811, such as in FIGS. 9C and 9D, for example. The type of schedule information that may be displayed in the cell 811 may change in one or more stages in accordance with the change in the size of the cell 811. For example, the term ‘schedule information’ may include an icon matched to a particular cell and a scheduled event stored in connection with the icon.

In response to the cell 811 being enlarged by a pinch-in operation performed by the user, not only the ‘conference’ icon 50 and the ‘hospital’ icon 60 but also their respective scheduled events may be displayed in the cell 811. The amount of schedule information displayed in the cell 811 may be determined by the degree to which the cell 811 is enlarged.

Referring to FIG. 9C, in response to the cell 811 being enlarged to a first reference level, the ‘conference’ icon 50 and the ‘hospital’ icon 60 and the titles of their respective scheduled events, i.e., “Attend Conference” and “Hospital Appointment,” are displayed in the cell 811. Referring to FIG. 9D, in response to the cell 811 being further enlarged to a second reference level, detailed information of the scheduled event corresponding to the ‘conference’ icon 50 (i.e., “Attendees: Hyunchul Kim, Kildong Hong” and “Location: Star Tower in Yeoksam-dong”) and detailed information of the scheduled event corresponding to the ‘hospital’ icon 60 (i.e., “Time: 3 P.M.” and “Location: Seoul National University Hospital”) are also be displayed in the cell 811.

In the examples illustrated in FIGS. 9C and 9D, the content of upper-level text data corresponding to a scheduled event and the title and content of lower-level text data corresponding to the scheduled event may be displayed. According to another example, the title and the content of the upper-level text data and the title and the content of the lower-level text data may be displayed. According to still another example, only the content of the upper-level text data and the content of the lower-level text data may be displayed.

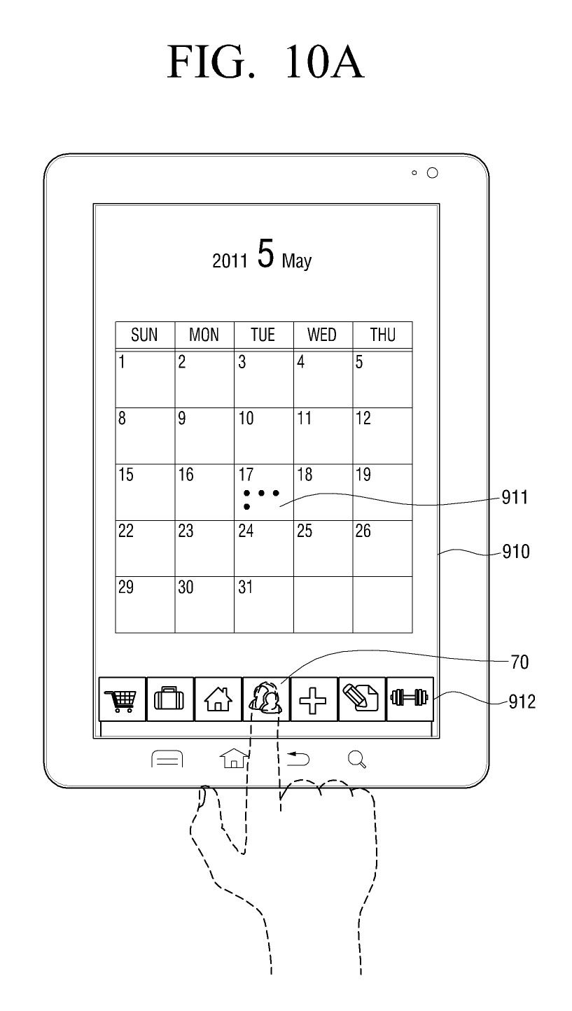

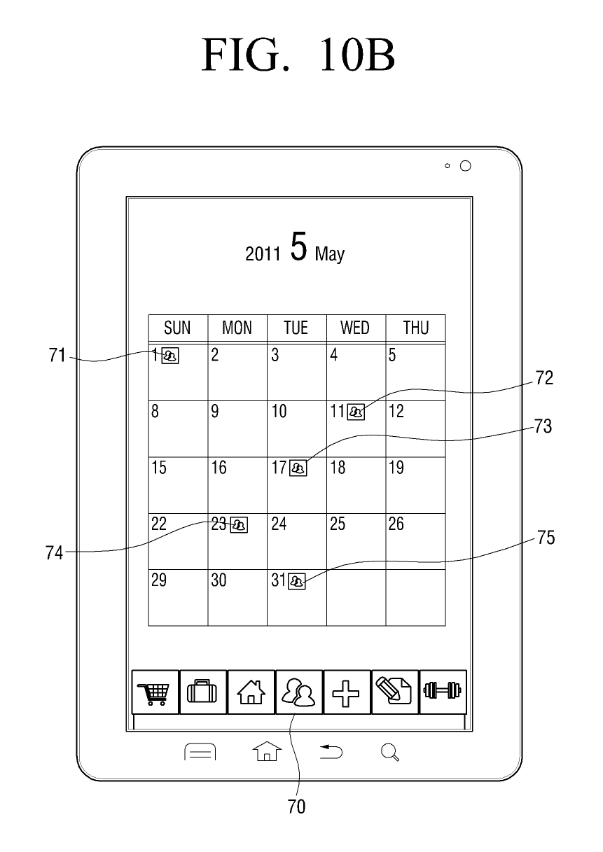

FIGS. 10A and 10B are diagrams illustrating an example of searching for an icon from a schedule table according to an embodiment of the present invention.

Referring to FIG. 10A, in response to a cell 911 in which a plurality of dots are displayed being touched by a user, an icon list 912 including a plurality of scheduled event-matched icons that are stored in connection with the cell 911 is displayed on one side of a schedule table 910. The display of an icon list in response to a cell being selected from a schedule table is described hereinabove with reference to FIGS. 8A and 8B, and thus, a further detailed description thereof is omitted.

In response to selection of one of the scheduled event-matched icons in the icon list 912, such as shown in FIG. 10A, the selected icon is displayed in one or more cells of the schedule table 910 that are matched with the selected icon, such as shown in FIG. 10B. In this manner, it is possible for the user to easily recognize the dates that are scheduled for a scheduled event corresponding to the selected icon.

For example, referring to FIGS. 10A and 10B, in response to a ‘conference’ icon 70 being selected from the icon list 912, the ‘conference’ icon 70 is displayed in one or more cells that are matched to the ‘conference’ icon 70 (i.e., the cells corresponding to the dates of May 1, 2011, May 11, 2011, May 17, 2011, May 23, 2011, and May 31, 2011) as indicated by reference numerals 71 to 75.

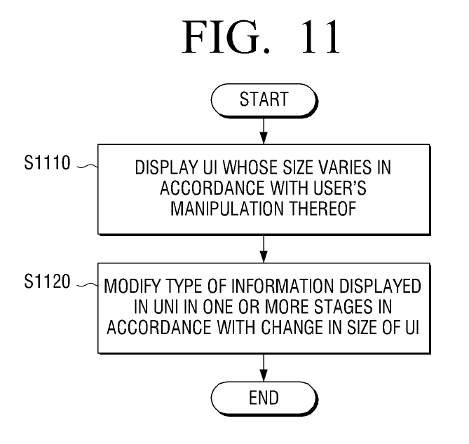

FIG. 11 is a flowchart illustrating a UI providing method of a display apparatus, according to an embodiment of the present invention.

Referring to FIG. 11, a UI whose size varies in response to a user's manipulation thereof is displayed, in step S1110. The type of information displayed in the UI is changed in one or more stages in accordance with the state of the manipulation of the size of the UI, in step S1120. For example, in step S1120, when a UI is displayed at a minimum size, one or more icons may be displayed in the UI, and, in response to the UI being enlarged, text data with gradual depth according to a predetermined hierarchical structure may also be displayed in the UI.

According to a particular case, a table UI that is divided into a plurality of cells may be displayed, and, in response to a data-written cell being selected from among the plurality of cells, a UI whose size can vary may be displayed for the selected cell. For example, the UI displayed in step S1110 may be a table UI that is divided into a plurality of cells, and, in step S1120, in response to the size of a data-written cell, among other cells in the table UI, changing, the type of information displayed in the data-written cell may be changed in one or more stages in accordance with a change in the size of the data-written cell.

The size of the UI displayed in step S1110 may be adjusted by a pinch-in operation or a pinch-out operation, for example.

The method illustrated in FIG. 11 may also include displaying a schedule table including a plurality of cells, storing schedule information, including an icon and a scheduled event set by the user, in connection with one of the cells selected by the user, generating a UI whose size can vary in response to the selected cell being selected again by the user, and displaying schedule information matched to the selected cell in the UI.

For example, the UI displayed in step S1110 may be a schedule table including a plurality of cells. In this example, the method illustrated in FIG. 11 may also include storing schedule information, including an icon and a scheduled event set by the user, in connection with one of the cells selected by the user.

For example, in a case in which a plurality of pieces of schedule information is matched to a cell of a schedule table, the plurality of pieces of schedule information may be displayed in chronological order.

For example, an icon selection UI for selecting an icon may be displayed, and, in response to an icon being selected via the icon selection UI, a scheduled event UI for entering a scheduled event in connection with the selected icon may be displayed. In this example, the scheduled event entered via the scheduled event UI may be stored in connection with the selected icon.

For example, in response to the occurrence of a predefined event, an icon list including one or more scheduled event-matched icons may be displayed on one side of a schedule table. In this example, at least one of the scheduled event-matched icons may be stored in connection with at least one cell of the schedule table in response to the receipt of a user command.

For example, in response to a cell being selected from a schedule table, at least one icon, if any, matched to the selected cell may be displayed on one side of the schedule table. In this example, in response to one of the displayed icons being selected, the selected icon may be displayed in one or more cells of the schedule table to which the selected icon is matched.

The foregoing embodiments and advantages are merely provided as examples and are not to be construed as limiting the present invention. The present disclosure can be readily applied to other types of apparatuses. Also, the description of embodiments of the present invention is intended to be illustrative, and not to limit the scope of the claims, and many alternatives, modifications, and variations will be apparent to those skilled in the art.

What is claimed is:

1. A display apparatus comprising:
a display unit for displaying a User Interface (UI) having a size that varies in response to a user's manipulation of the display unit; and
a control unit for changing a type of information displayed in the UI in at least one stage in accordance with a state of the manipulated size of the UI.

2. The display apparatus of claim 1, wherein the control unit displays the information in the UI as an icon in response to the UI being displayed at a minimum size and additionally displays text data with a gradually increasing hierarchical depth according to a predetermined hierarchical structure in the UI in response to the UI being enlarged, the text data corresponding to the icon.

3. The display apparatus of claim 1, wherein the UI includes a table UI that is divided into a plurality of cells, and the control unit controls the display unit to display the UI in response to selection of a cell into which the information is written from among the plurality of cells.

4. The display apparatus of claim 1, wherein the UI includes a table UI that is divided into a plurality of cells, and, in response to a change of a size of one of the plurality of cells into which the information is written, the control unit changes the type of the information in at least one stage in accordance with a change in the size of the size-changed cell.

5. The display apparatus of claim 1, wherein the size of the UI is adjusted according to at least one of a pinch-in operation and a pinch-out operation.

6. The display apparatus of claim 1, further comprising:
a storage unit,
wherein the display unit displays a schedule table including a plurality of cells, and, in response to a cell being selected from among the plurality of cells, the control unit stores schedule information, including an icon and a scheduled event set by a user, in the storage unit in connection with the selected cell, and
wherein, in response to the selected cell being selected again later, the control unit generates the UI and displays the schedule information in the UI.

7. The display apparatus of claim 6, wherein, in response to a plurality of schedule information items being matched to the selected cell, the control unit displays the plurality of schedule information items in chronological order according to respective scheduled events corresponding to each schedule information item.

8. The display apparatus of claim 6, wherein the display unit displays an icon selection UI for selecting an icon, and displays a scheduled event UI for entering a scheduled event in response to selection of an icon from the icon selection UI, and the control unit stores a scheduled event entered via the scheduled event UI in connection with the selected icon.

9. The display apparatus of claim 8, wherein, in response to occurrence of a predefined event, the control unit displays an icon list including at least one icon matched with a corresponding scheduled event on one side of the schedule table, and stores at least one of the schedule event-matched icons in connection with at least one of the cells of the schedule table in response to receipt of a user command.

10. The display apparatus of claim 6, wherein, in response to selection of a cell from the schedule table, the display unit displays at least one icon that is matched to the selected cell on one side of the schedule table.

11. The display apparatus of claim 10, wherein, in response to selection of one of the displayed icons, the control unit controls the display unit to display the selected icon in at least one cell of the schedule table to which the selected icon is matched.

12. The display apparatus of claim 1, further comprising:
a storage unit,
wherein the UI includes a schedule table including a plurality of cells, and in response to selection of a cell from the schedule table, the control unit stores schedule information, including an icon and a scheduled event set by a user, in the storage unit in connection with the selected cell.

13. The display apparatus of claim 12, wherein, in response to a plurality of schedule information items being matched to the selected cell, the control unit displays the plurality of schedule information items in chronological order according to respective scheduled events corresponding to each schedule information item.

14. The display apparatus of claim 12, wherein the display unit displays an icon selection UI for selecting an icon, and displays a scheduled event UI for entering a scheduled event in response to selection of an icon from the icon selection UI, and the control unit stores a scheduled event entered via the scheduled event UI in connection with the selected icon.

15. The display apparatus of claim 14, wherein, in response to an occurrence of a predefined event, the control unit displays an icon list including at least one icon matched with a corresponding scheduled event, on one side of the schedule table, and stores at least one of the schedule event-matched icons in connection with at least one of the cells of the schedule table in response to receipt of a user command.

16. The display apparatus of claim 12, wherein, in response to selection of a cell from the schedule table, the display unit displays at least one icon that is matched to the selected cell on one side of the schedule table.

17. The display apparatus of claim 16, wherein, in response to selection of one of the displayed icons, the control unit controls the display unit to display the selected icon in at least one cell of the schedule table to which the selected icon is matched.

18. A method of providing a UI, the method comprising:
displaying a UI having a size that varies in response to a user's manipulation thereof; and
changing a type of information displayed in the UI in at one stage in accordance with a state of the manipulated size of the UI.

19. The method of claim 18, wherein changing the type of information displayed comprises:
displaying the information in the UI as an icon in response to the UI being displayed at a minimum size; and
additionally displaying text data with a gradually increasing hierarchical depth according to a predetermined hierarchical structure in the UI in response to the UI being enlarged, the text data corresponding to the icon.

20. The method of claim 18, further comprising:
displaying a table UI that is divided into a plurality of cells,
wherein the displaying the table UI comprises displaying the UI in response to selection of a cell into which the information is written from among the plurality of cells.

21. The method of claim 18, wherein the UI includes a table UI that is divided into a plurality of cells, and
wherein changing the type of information displayed comprises, in response to a change of a size of one of the plurality of cells into which the information is written, changing the type of the information in at least one stage in accordance with a change in the size of the size-changed cell.

22. The method of claim 18, wherein the size of the UI is adjusted according to at least one of a pinch-in operation and a pinch-out operation.

23. The method of claim 18, further comprising:
displaying a schedule table including a plurality of cells;
storing, in response to selection of a cell from among the plurality of cells, schedule information that includes an icon and a scheduled event set by a user, in connection with the selected cell; and
generating in response to the selected cell being selected again later, the UI and displaying the schedule information in the UI.

24. The method of claim 23, wherein displaying the schedule table comprises displaying, in response to a plurality of schedule information items being matched to the selected cell, the plurality of schedule information items in chronological order according to respective scheduled events corresponding to each schedule information item.

25. The method of claim 23, further comprising:
displaying an icon selection UI for selecting an icon and displaying a scheduled event UI for entering a scheduled event in response to selection of an icon from the icon selection UI; and
storing a scheduled event entered via the scheduled event UI in connection with the selected icon.

26. The method of claim 25, further comprising:
displaying, in response to occurrence of a predefined event, an icon list including at least one icon matched with a corresponding scheduled event, on one side of the schedule table; and
storing at least one of the schedule event-matched icons in connection with at least one of the cells of the schedule table in response to receipt of a user command.

27. The method of claim 23, further comprising:
displaying, in response to selection of a cell from the schedule table, at least one icon that is matched to the selected cell on one side of the schedule table.

28. The method of claim 27, further comprising:
displaying, in response to selection of one of the displayed icons, the selected icon in at least one cell of the schedule table to which the selected icon is matched.

29. The method of claim 18, wherein the UI includes a schedule table including a plurality of cells, and
wherein the method further comprises storing, in response to selection of a cell from the schedule table, schedule information that includes an icon and a scheduled event set by a user, in connection with the selected cell.

30. The method of claim 29, further comprising:
displaying, in response to a plurality of schedule information items being matched to the selected cell, the plurality of schedule information items in chronological order according to respective scheduled events corresponding to each schedule information item.

31. The method of claim 29, further comprising:
displaying an icon selection UI for selecting an icon and displaying a scheduled event UI for entering a scheduled event in response to selection of an icon from the icon selection UI; and
storing a scheduled event entered via the scheduled event UI in connection with the selected icon.

32. The method of claim 31, further comprising:
displaying, in response to an occurrence of a predefined event, an icon list including at least one icon matched with a corresponding scheduled event, on one side of the schedule table; and
storing at least one of the schedule event-matched icons in connection with at least one of the cells of the schedule table in response to receipt of a user command.

33. The method of claim 29, further comprising:
displaying, in response to selection of a cell from the schedule table, at least one icon that is matched to the selected cell on one side of the schedule table.

34. The method of claim 33, further comprising:
displaying, in response to selection of one of the displayed icons, the selected icon in at least one cells of the schedule table to which the selected icon is matched.
